(19) United States
(12) Patent Application Publication
(10) Pub. No.: US 2021/0170427 A1
(43) Pub. Date: Jun. 10, 2021

(54) ALTERNATING WATER DELIVERY DEVICE

(71) Applicant: RUNNER(XIAMEN) CORP., XIAMEN (CN)

(72) Inventors: Dexiang YE, XIAMEN (CN); Xinzhan HU, XIAMEN (CN); Quanlao WANG, XIAMEN (CN)

(21) Appl. No.: 17/106,148

(22) Filed: Nov. 29, 2020

(30) Foreign Application Priority Data
Dec. 6, 2019 (CN) 201911239549.5

(51) Int. Cl. B05B 1/16; F15D 1/06

(52) U.S. Cl. CPC B05B 1/16; F15D 1/06

(57) ABSTRACT

Disclosed is an alternating water delivery device, comprising body, a chamber is inside the body, and the upper part of the body is provided with an water inlet which is connected to the chamber, and the lower part of the body is provided with a first water outlet and a second water outlet which are both connected to the chamber, and a first direction of water flow is formed between the water inlet and the first water outlet, and a second direction of water flow is formed between the water inlet and the second water outlet, and the body is also provided with a first load and a second load respectively connected to the first water outlet and the second water outlet, and said chamber is also provided with a first feedback water circuit and a second feedback water circuit, the inlet end of said first feedback water circuit is joined to the first direction of water flow, and the outlet end of said first feedback water circuit is joined to the outlet end of the water inlet, and the inlet end of the second feedback water circuit is joined to the second direction of water flow, and the outlet end of the second feedback water circuit is joined to the outlet end of the water inlet. The invention is an oscillating water discharge device that can be installed with loads, and has low flow and pressure losses.

### CROSS-REFERENCE TO RELATED APPLICATIONS

This application claims priority to China Patent application No. 201911239549.5 filed Dec. 6, 2019, all of which are hereby incorporated herein in their entireties by reference.

### FIELD AND BACKGROUND OF THE INVENTION

### 1. Technical Field

The present invention relates to an alternating water delivery device.

### 2. Description of Related Art

Fluid self-excited oscillators are well known in the prior art for their ability to provide a ide range of fluid spray modes or particle scattering modes by deflecting a fluid jet with a periodic feedback signal stream without the use of mechanical moving parts. Thus, the advantage of fluid oscillators is that they are not subject to mechanical motion wear, which can adversely affect the reliability and operation of the discharge device. Existing fluid oscillators already produce an oscillating elect as the fluid leaves the jet element. There are significant losses in fluid flow and pressure. In addition, when using loads with large flow restrictions. It is prone to jet element failure and disorganized fluid distribution.

In addition, existing fluidic oscillators are used only in spray or pellet mode, and the experience as a shower is monotonous.

### SUMMARY OF THE INVENTION

To overcome the defects mentioned above, the present invention provides an alternating water delivery device.

An alternating water delivery device, comprising, body, and a chamber is inside the body, and the upper part of the body is provided with an water inlet which is connected to the chamber, and the lower part of the body is provided with a first water outlet and a second water outlet which are both connected to the chamber, and a first direction of water flow is formed between the water inlet and the first water outlet, and a second direction of water flow is formed between the water inlet and the second water outlet, and the body is also provided with a first load and a second load respectively connected to the first water outlet and the second water outlet, and said chamber is also provided with a first feedback water circuit and a second feedback water circuit, the inlet end of said first feedback water circuit is joined to the first direction of water flow, and the outlet end of said first feedback water circuit is joined to the outlet end of the water inlet, and the inlet end of the second feedback water circuit is joined to the second direction of water flow, and the outlet end of the second feedback water circuit is joined to the outlet end of the water inlet.

Further, the caliber of the outlet end of said water inlet is smaller than the caliber of the inlet end of said water inlet.

Further, said chamber is provided with a first inclined sidewall and a second inclined sidewall, and the water in the first direction of water flow flows along the first inclined sidewall to the first water outlet, and the water in the second direction of water flow flows along the second inclined sidewall to the second water outlet.

Further, the inlet end of the first feedback water circuit is set at the connection of the first direction of water flow and the first water outlet, and the outlet waterway of the first feedback water circuit is a first inclined water circuit, and the water flowing from the first inclined water circuit joins the water flowing out of the water inlet.

Further, the inlet end of the second feedback water circuit is set at the connection of the second direction of water flow and the second water outlet, and the outlet waterway of the second feedback water circuit is a second inclined water circuit, and the water flowing from the second inclined water circuit joins the water flowing out of the water inlet.

Further, a convex plat corresponding to the water inlet is provided between the first water outlet and the second water outlet, and an arc-shaped groove is set on the top of the convex plat.

Further, the body is also provided with a first outlet chamber and a second outlet chamber, and said first outlet chamber is connected to the first water outlet, and said second outlet chamber is connected to the second water outlet, and said first load is connected to the first outlet chamber, and said second load is connected to the second outlet chamber.

Further, the bottom of said arc-shaped groove is set on the same level with the inlet end of the first water outlet and the inlet end of the second water outlet.

Further, the caliber of the outlet end of the water inlet is W, the distance between the outlet end of the first inclined water circuit and the outlet end of the second inclined water circuit D=(1.5˜3)*W; the pore size of the first water outlet is T=(1˜3)*W, the pore size of the second water outlet is T=(1˜3)*W; the distance between the outlet end of said water inlet and the bottom of the arc-shaped groove is L=(9˜20)*W.

Further, the angle between the first direction of water flow and the second direction of water flow is α=20°˜32°; the angle between outlet direction of the first inclined water circuit and outlet direction of the water inlet is β=72°˜84°.

According to the present invention, the alternating water delivery device is simple, low cost, and relaxes scaling requirements for critical dimensions. Furthermore, the alternating water delivery device reduces the pressure loss of fluid while through the jet element, and achieves a variety of pulsing and alternating effects of water spray.

### BRIEF DESCRIPTION OF THE DRAWINGS

The present invention is further described with the drawings as follows.

FIG. 1 is an sectional diagram in one embodiment of the present invention.

FIG. 2 is an exploded diagram in one embodiment of the present invention.

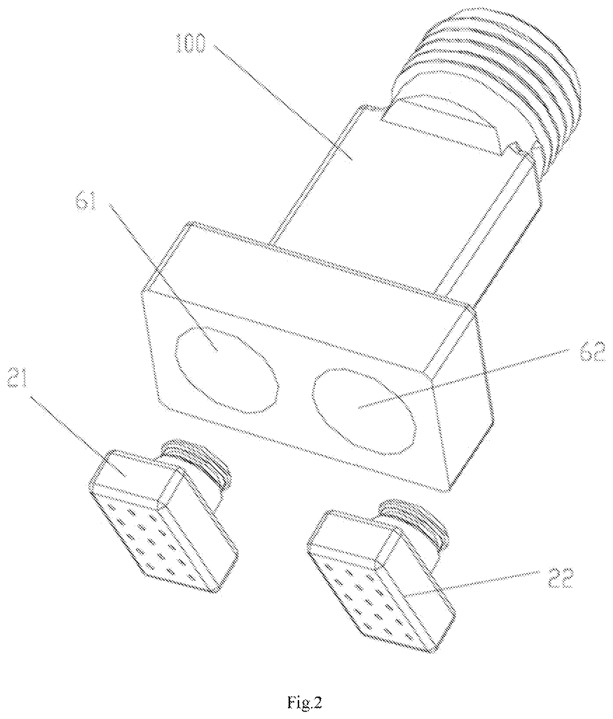

FIG. 3 is a schematic diagram in one embodiment of the present invention.

FIG. 4 is a schematic diagram of first state in one embodiment of the present invention.

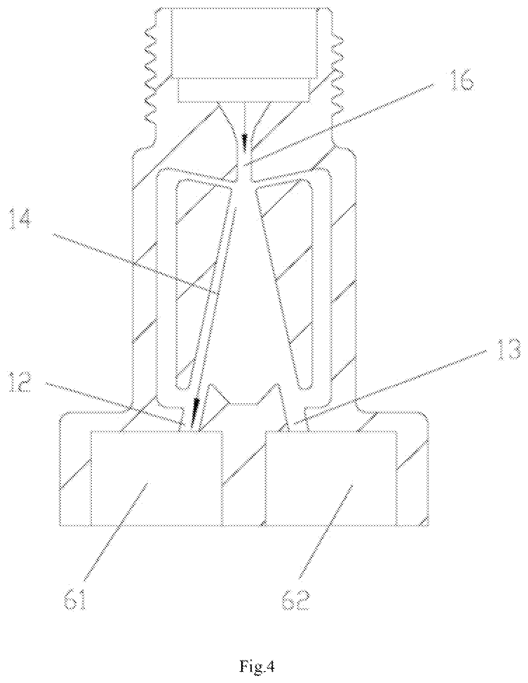

FIG. 5 is a schematic diagram of second state in one embodiment of the present invention.

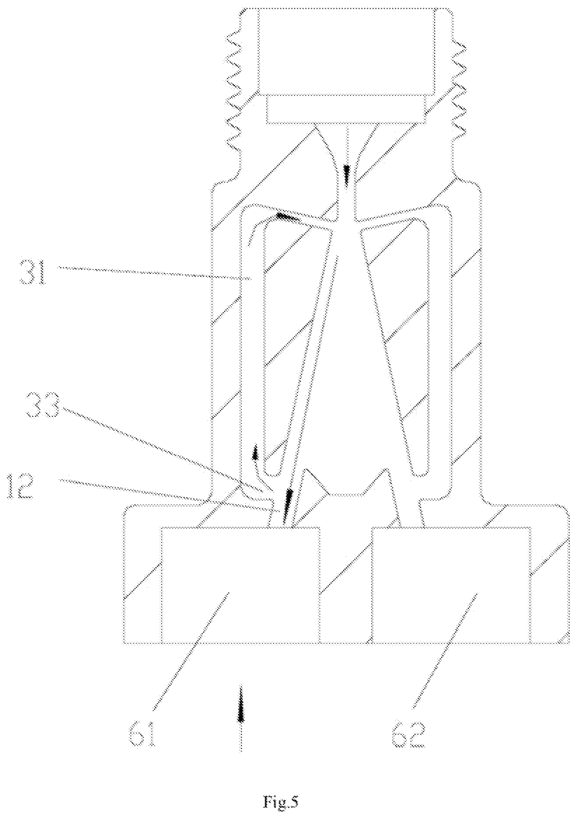

FIG. 6 is a schematic diagram of third state in one embodiment of the present invention.

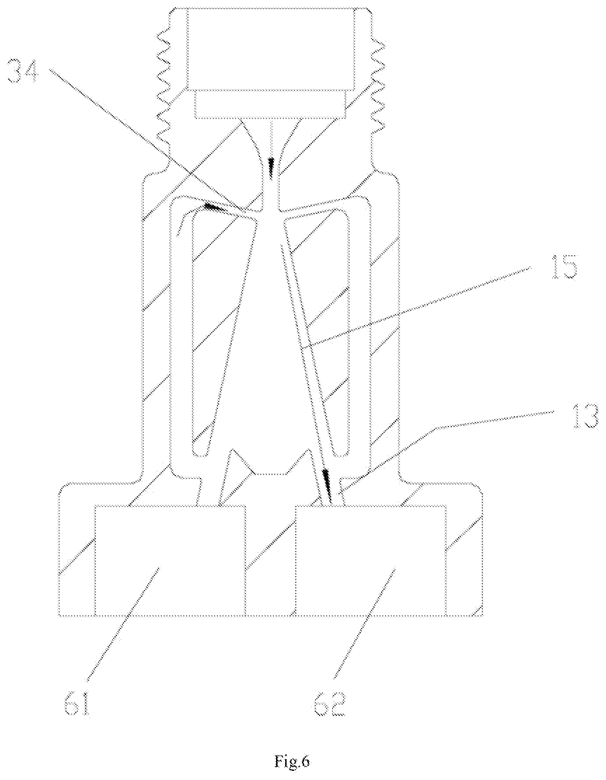

FIG. 7 is a schematic diagram of fourth state in one embodiment of the present invention.

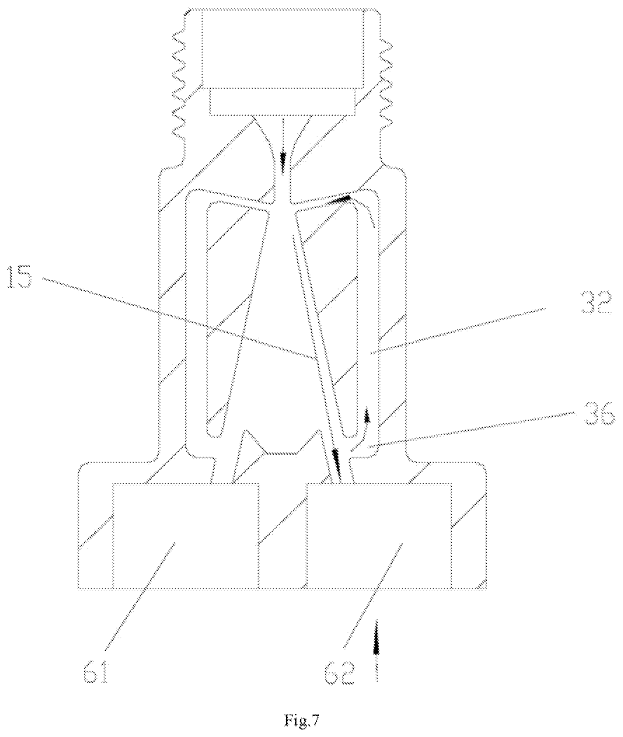

FIG. 8 is a schematic diagram of fifth state in one embodiment of the present invention.

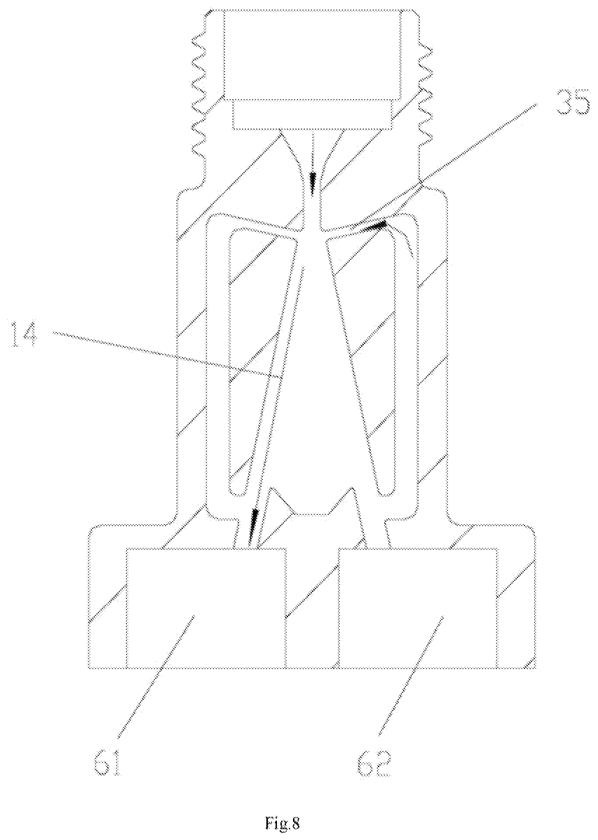

FIG. 9 is a schematic diagram of first example of two loads of the present invention.

FIG. 10 is a schematic diagram of second example of two loads of the present invention.

FIG. 11 is a schematic diagram of third example of two loads of the present invention.

FIG. 12 is a schematic diagram of fourth example of two loads of the present invention.

FIG. 13 is a schematic diagram of fifth example of two loads of the present invention.

### DESCRIPTION OF THE PREFERRED EMBODIMENTS

A further description of the present invention is given as follows with the drawings and specific embodiment. Obviously, the described embodiments are only some, but not all, of the embodiments of the invention. Based an the embodiments in the present invention, all other embodiments obtained by one of ordinary skill in the art without inventive work are within the scope of protection of the present invention.

The term “an embodiment” or “embodiment” as used herein refers to a particular feature, structure or characteristic that may be included in at least one embodiment of the invention. In the description of the present invention, it is to be understood that the terms “up”, “down”, “top”, “bottom”, etc. indicating orientation or posit on relationships based on those shown in the drawings are used only to facilitate the description of the invention and simplify the description, and do not indicate or imply that the devices or components referred to must have a particular orientation, or be constructed and operate in a particular orientation, and therefore they are not to be construed as a limitation of the invention. Furthermore, the terms “first” and “second” are used only for descriptive purposes and are not to be understood as indicating or implying a relative importance or implicitly specifying the number of technical features indicated. Thus, a feature that qualifies as “first”, “second”, etc. may explicitly or implicitly include one or more of those features. Moreover, the terms “first”, “second”, etc. are used to distinguish between similar objects and need not be used to describe a particular order or sequence. It should to be understood that the data used may be interchangeable while it is appropriate, so that the embodiments described herein may be practiced in an order other than those illustrated or described herein.

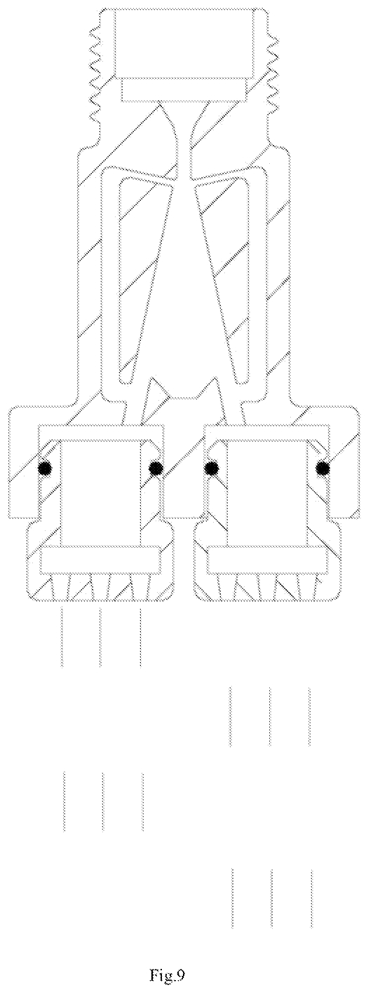

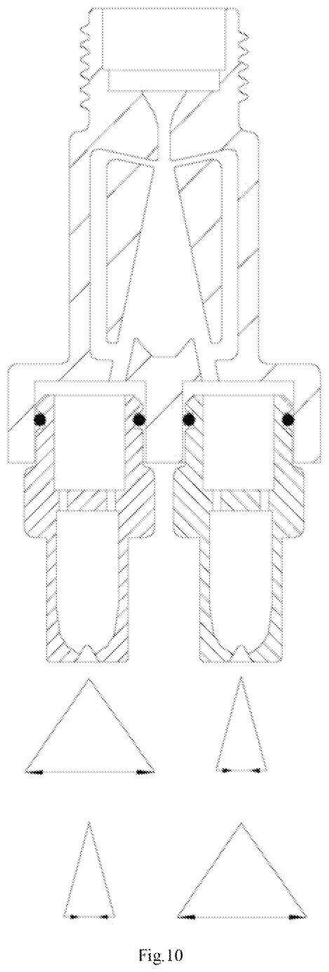

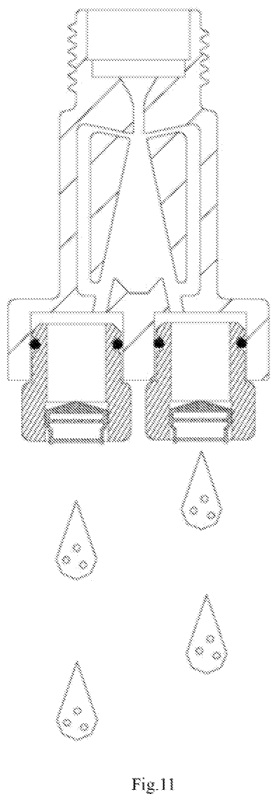

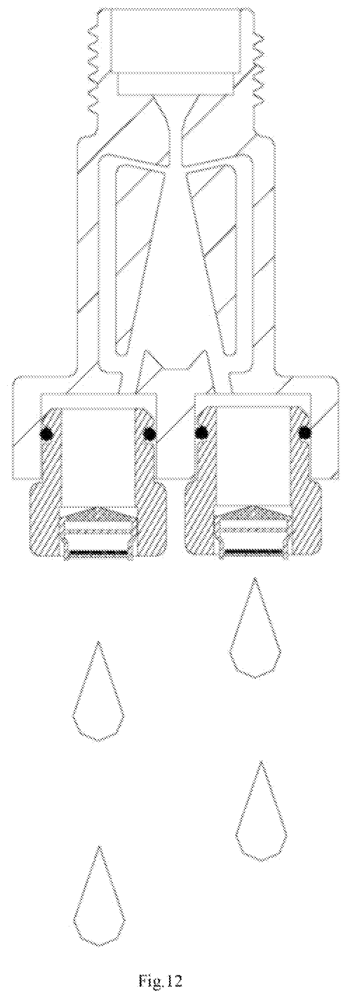

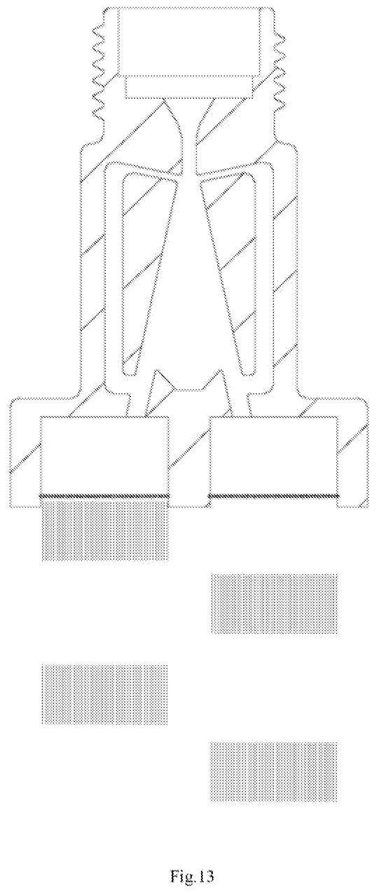

As is shown in FIGs. The present invention provides an alternating water delivery device, comprising body 100, and a chamber 10 is inside the body, and the upper part of the body is provided with an water inlet 11 which is connected to the chamber, and the lower part of the body is provided with a first water outlet 12 and a second water outlet 13 which are both connected to the chamber, and a first direction of water flow 14 is formed between the water inlet and the first water outlet, and a second direction of water flow 15 is formed between the water inlet and the second water outlet. In the use of the invention, the first direction of water flow and the second direction of water flow will not pass through water at the same time. The body is also provided with a first load 21 and a second load 22 respectively connected to the first water outlet and the second water outlet. The first load and the second load can be the same product and can be the water outlet module. The difference in water outlet of two loads can create different water splash effects, which refer to the illustration in FIG. 9-FIG. 13. In FIG. 9, two loads are multi hole sprinkler board, whose water spray form is regional pulse water. In FIG. 10, the two loads are fan-shaped nozzles, whose water spray forms is fan-shaped water, the opening angle of which is periodic. In FIG. 11, the two loads are porous outlet nozzles with air suction, whose water spray form is large droplets water with bubbles. In FIG. 12, the two loads are porous outlet nozzles with filter screen, whose water spray is large droplets water. In FIG. 13, the two loads are thin sheet with multiple pores, whose water spray form is thin pulse water. Said chamber is also provided with a first feedback water circuit 31 and a second feedback water circuit 32, the first feedback water circuit and the second feedback water circuit do not though water in the same time. The inlet end of said first feedback water circuit is joined to the first direction of water flow, and the outlet end of said first feedback water circuit is joined to the outlet end of the water inlet 16, and the inlet end of the second feedback water circuit is joined to the second direction of water flow, and the outlet end of the second feedback water circuit is joined to the outlet end of the water inlet, which means, part of the water flowing from the first direction of water flow flows into the first feedback water circuit, and then joins the water flowing from the water inlet, and part of the water flowing from the second direction of water flow flows into the second feedback water circuit, and then joins the water flowing from the water inlet, the two water flow states are alternating.

In order to create negative pressure and a better Venturi effect when the water enters, the caliber of the outlet end of said water inlet is smaller than the caliber of the inlet end of said water inlet. Referring specifically to the Figs attached to the instructions, the aperture of the water inlet is gradually decreasing in the direction of the water flow, and then a water channel is formed at the outlet end of the water inlet which has the minimum aperture.

Further, said chamber is provided with a first inclined sidewall 41 and a second inclined sidewall 42, and the water in the first direction of water flow flows along the first inclined sidewall to the first water outlet, and the water in the second direction of water flow flows along the second inclined sidewall to the second water outlet.

Further, the inlet end of the first feedback 33 water circuit is set at the connection of the first direction of water flow and the first water outlet, and the outlet waterway of the first feedback water circuit is a first inclined water circuit 34, and the water flowing from the first inclined water circuit joins the water flowing out of the water inlet.

Further, the inlet end of the second feedback water circuit 35 is set at the connection of the second direction of water flow and the second water outlet, and the outlet waterway of the second feedback water circuit is a second inclined water circuit 36, and the water flowing from the second inclined water circuit joins the water flowing out of the water inlet.

Further, a convex plat 50 corresponding to the water inlet is provided between the first water outlet and the second water outlet, and an arc-shaped groove 51 is set on the top of the convex plat.

Further, the body is also provided with a first outlet chamber 61 and a second outlet chamber 62, and said first outlet chamber is connected to the first water outlet, and said second outlet chamber is connected to the second water outlet, and said first load is connected to the first outlet chamber, and said second load is connected to the second outlet chamber. The water flowing out of the first water outlet flows into the first outlet chamber, and then flows out of the first load. The water flowing out of the second water outlet flows into the second outlet chamber, and them flows out of the second load.

Further, the bottom of said arc-shaped groove is set on the same level with the inlet end of the first water outlet and the inlet end of the second water outlet.

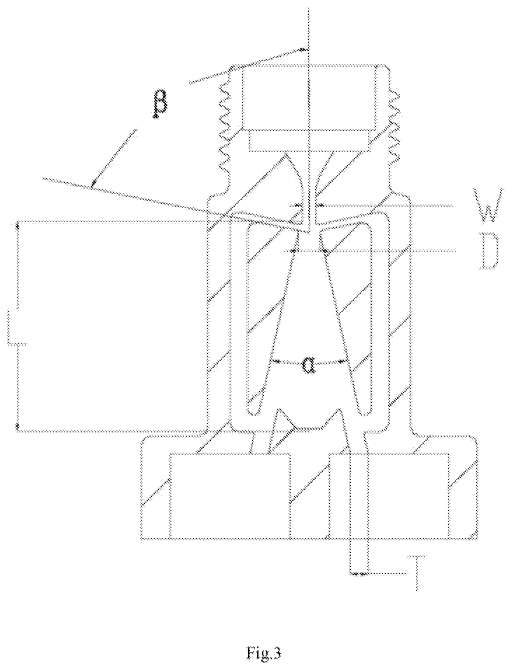

Refer to FIG. 3, the caliber of the outlet end of the water inlet is W, the size of this caliber is 0.4˜3 mm, and can be 0.4 mm, 0.6 mm, 0.9 mm, 1.1 mm, 1.4 mm, 1.7 mm, 2 mm, 2.4 mm, 2.6 mm, 2.7 mm or 3 mm. In order to better ensure the stability of water flow switching, the distance between the outlet end of the first inclined water circuit and the outlet end of the second inclined water circuit D=(1.5˜3)*W. The outlet end of the first inclined water circuit and the outlet end of the second inclined water circuit are located on two sides of the outlet end of the water inlet, which can also be symmetrical. The distance D can be 1.5 W, 1.6 W, 1.8 W, 2 W, 2.2 W, 2.3 W, 2.5 W, 2.8 W or 3 W. The pore size of the first water outlet is T=(1˜3)* W, the pore size of the second water outlet is T=(1˜3)*W. The pore size of the first water outlet and the second water outlet can be the same or different, as long as the pore size is within the set range. The pore size of the first water outlet and the second water outlet can be 1 W, 1.2 W, 1.4 W, 1.7 W, 2 W, 2.1 W, 2.3 W, 2.4 W, 2.7 W, 2.8 W or 3 W. the distance between the outlet end of said water inlet and the bottom of the arc shaped groove is L=(9˜20)*W. The distance L can be 9 W, 10 W, 12 W, 14 W, 15 W, 16 W, 17 W, 18 W or 20 W. The angle between the first direction ⁻f water flow and the second direction of water flow is α=20°˜32°. The angle α can be 20°, 22°, 23°, 24°, 26°, 27°, 29°, 30° or 32°. The angle between outlet direction of the first inclined water circuit and outlet direction of the water inlet is β=72°˜84°. The angle β can 72°, 74°, 75°, 78°, 80°, 81° or 84°.

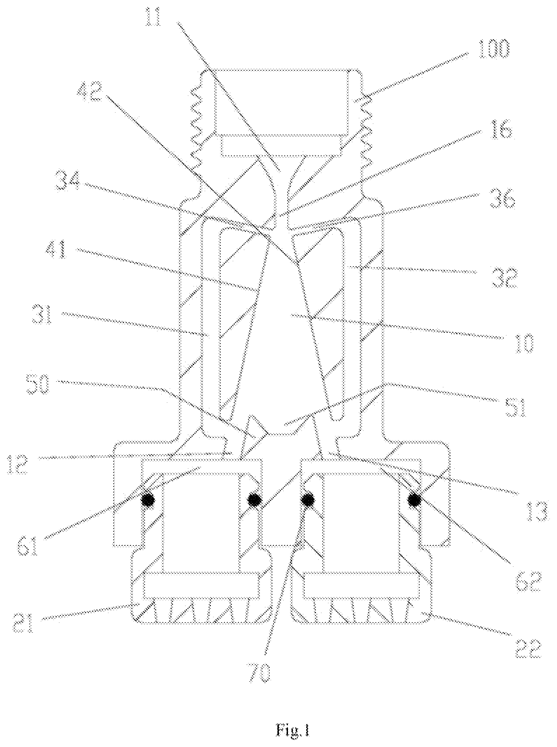

The present invention overcomes the challenges of the background technology by providing a fluid oscillator structure and fluid distribution generation method based on a load feedback signal flow so as to expand the use of the oscillator. The main body itself can drive the mainstream to deflect without oscillations by using the static pressure generated by the load to generate a strong feedback signal flow. In this invention: the water flows into the chamber of the body through the water inlet, through a narrow channel at the outlet end of the water inlet whose caliber is smaller, generating a venturi effect, the flow rate increases, the static pressure at the outlet end of the water inlet decreases, and the mainstream is attached to the first inclined sidewall or the second inclined sidewall under the Coanda effect, and after the vortex effect of the chamber (generated by the water flowing directly in the arc-shape groove), the water enters the first or second water outlet. Referring to the Figs. attached to the instructions, with water flowing attached to the first inclined sidewall and water flowing in the direction of the first direction of water flow as first state. When the water enters the first water outlet, due to the negative pressure at the outlet end of the water inlet, the first feedback water circuit begins to absorb part of the water flow, forming a branch flow as a feedback signal flow, the feedback signal flow passes to the outlet end of the water inlet, which is second state. When the first load is filled with water, the static pressure of the first outlet chamber rises, the pressure through the first feedback water circuit to the outlet end of the water inlet, so that the left pressure of mainstream is greater than the right pressure of mainstream, driving the mainstream to deflect and be attached to the second inclined sidewall, and then the water flows along the second direction of water flow and flows to the second water outlet, which is third state. As the water flows into the second water outlet, due to the negative pressure at the outlet end of the water inlet, the second feedback water circuit begins to absorb part of the water flow, forming a branch flow as a feedback signal flow, the feedback signal flow is transmitted to the outlet end of the water inlet, which is fourth state. When the second load is filled with water, the static pressure of the second outlet chamber rises, this pressure is transferred to the outlet end of the water inlet through the second feedback water circuit, so that the left side pressure of the mainstream is greater than the right side pressure of the mainstream, driving the mainstream to deflect and be attached to the the first inclined sidewall, and the water flows along the first direction of water flow, flowing to the first water outlet, which is fifth state. Then go to state one again, cycling through the above states. The first load and the second load are not plotted in the diagram of first state to fifth state. The first load and the second load are in the same relationship as in the other Figs. Referring to FIG. 1, a seal 70 is provided between the two toads and two outlet chambers.

The above description shows and describes preferred embodiments of the invention. As mentioned above, it should be understood that the invention is not limited to the forms disclosed herein, should not he regarded as an exclusion of other embodiments, but can he used for various other combinations, modifications and environments, and can be modified by the above-mentioned teaching or technology or knowledge in related fields within the scope of the invention concept described herein. However, the modifications and changes made by personnel in the art do not deviated from the spirit and scope of the invention shall be within the protection scope of the claims attached to the invention.

What is claimed is:

1. An alternating water delivery device, comprising body, wherein a chamber is inside the body, and the upper part of the body is provided with an water inlet which is connected to the chamber, and the lower part of the body is provided with a first water outlet and a second water outlet which are both connected to the chamber, and a first direction of water flow is formed between the water inlet and the first water outlet, and a second direction of water flow is formed between the water inlet and the second water outlet, and the body is also provided with a first load and a second load respectively connected to the first water outlet and the second water outlet, and said chamber is also provided with a first feedback water circuit and a second feedback water circuit, the inlet end of said first feedback water circuit is joined to the first direction of water flow, and the outlet end of said first feedback water circuit is joined to the outlet end of the water inlet, and the inlet end of the second feedback water circuit is joined to the second direction of water flow, and the outlet end of the second feedback water circuit is joined to the outlet end of the water inlet.

2. The alternating water delivery device according to claim 1, wherein the caliber of the outlet end of said water inlet is smaller than the caliber of the inlet end of said water inlet.

3. The alternating water delivery device according to claim 1, wherein said chamber is provided with a first inclined sidewall and a second inclined sidewall, and the water in the first direction of water flow flows along the first inclined sidewall to the first water outlet, and the water in the second direction of water flow flows along the second inclined sidewall to the second water outlet.

4. The alternating water delivery device according to claim 3, wherein the inlet end of the first feedback water circuit is set at the connection of the first direction of water flow and the first water outlet, and the outlet waterway of the first feedback water circuit is a first inclined water circuit, and the water flowing from the first inclined water circuit joins the water flowing out of the water inlet.

5. The alternating water delivery device according to claim 4, wherein the inlet end of the second feedback water circuit is set at the connection of the second direction of water flow and the second water outlet, and the outlet waterway of the second feedback water circuit is a second inclined water circuit, and the water flowing from the second inclined water circuit joins the water flowing out of the water inlet.

6. The alternating water delivery device according to claim 1, wherein a convex plat corresponding to the water inlet is provided between the first water outlet and the second water outlet, and an arc-shaped groove is set on the top of the convex plat.

7. The alternating water delivery device according to claim 6, wherein the body is also provided with a first outlet chamber and a second outlet chamber, and said first outlet chamber is connected to the first water outlet, and said second outlet chamber is connected to the second water outlet, and said first load is connected to the first outlet chamber, and said second load is connected to the second outlet chamber.

8. the alternating water delivery device according to claim 1, wherein that the caliber of the outlet end of the water inlet is W, the distance between the outlet end of the first inclined water circuit and the outlet end of the second inclined water circuit D=(1.5˜3)*W; the pore size of the first water outlet is T=(1˜3)*W, the pore size of the second water outlet is T=(1˜3)*W; the distance between the outlet end of said water inlet and the bottom of the arc-shaped groove is L=(9˜20)*W.

9. The alternating water delivery device according to claim 8, wherein the angle between the first direction of water flow and the second direction of water flow is α=20°˜32°; the angle between outlet direction of the first inclined water circuit and outlet direction of the water inlet is β=72°˜84°.

10. The alternating water delivery device according to Claim 3, wherein the caliber of the outlet end of said water inlet is smaller than the caliber of the inlet end of said water inlet.

11. The alternating water delivery device according to claim 6, wherein the caliber of the outlet end of said water inlet is smaller than the caliber of the inlet end of said water inlet.

12. The alternating water delivery device according to claim 6, wherein the inlet end of the first feedback water circuit is set at the connection of the first direction of water flow and the first water outlet, and the outlet waterway of the first feedback water circuit is a first inclined water circuit, and the water flowing from the first inclined water circuit joins the water flowing out of the water inlet.

13. The alternating water delivery device according to claim 6, wherein the inlet end of the second feedback water circuit is set at the connection of the second direction of water flow and the second water outlet, and the outlet waterway of the second feedback water circuit is a second inclined water circuit, and the water flowing from the second inclined water circuit joins the water flowing out of the water inlet.

14. The alternating water delivery device according to claim 8, wherein the caliber of the outlet end of said water inlet is smaller than the caliber of the inlet end of said water inlet.

15. The alternating water delivery device according to claim 8, wherein the inlet end of the first feedback water circuit is set at the connection of the first direction of water flow and the first water outlet, and the outlet waterway of the first feedback water circuit is a first inclined Water circuit, and the water flowing from the first inclined water circuit joins the water flowing out of the water inlet.

16. The alternating water delivery device according to claim 8, wherein the inlet end of the second feedback water circuit is set at the connection of the second direction of water flow and the second water outlet, and the outlet waterway of the second feedback water circuit is a second inclined water circuit, and the water flowing from the second inclined water circuit joins the water flowing out of the water inlet.

17. The alternating water delivery device according to Claim 8, wherein the body is also provided with a first outlet chamber and a second outlet chamber, and said first outlet chamber is connected to the first water outlet, and said second outlet chamber is connected to the second water outlet, and said first load is connected to the first outlet chamber, and said second load is connected to the second outlet chamber.
